(19) United States
(12) Patent Application Publication
(10) Pub. No.: US 2002/0143898 A1
(43) Pub. Date: Oct. 3, 2002

(54) System and method for providing personalized customer support

(76) Inventors: Michael A. Mansfield, Boise, ID (US); Donald J. Fridrich, Nampa, ID (US)

Correspondence Address: HEWLETT-PACKARD COMPANY, Intellectual Property Administration, P. O. Box 272400, Fort Collins, CO, 80527-2400, US

(21) Appl. No.: 09/819,427

(22) Filed: Mar. 27, 2001

(51) Int. Cl. G06F 15/16

(52) U.S. Cl. 709/219; 709/204

(57) ABSTRACT

The present disclosure relates to a system and method for providing personalized customer support. The method comprises receiving information from a customer, evaluating the customer information, identifying customer support information relevant to the customer information, and presenting the relevant customer support information to the customer. In a preferred arrangement, the method comprises automatically generating a personalized web page containing the customer support information particular to the customer and its business.

### FIELD OF THE INVENTION

The present disclosure relates to a system and method for personalized customer support. More particularly, the disclosure relates to a series of personalized web pages that are adapted to help customers with their particular needs.

### BACKGROUND OF THE INVENTION

Often, equipment and software vendors offer many different products for sale. Many such vendors offer customer support for these products online over the Internet. Because of the large number of products offered, it can be difficult for a customer to locate information about the products, and solve any problems the customer may be having with them. In addition, even if the customer can locate the relevant information as to a particular product or problem, the information may not be at the technical level best suited for that particular customer. For instance, the customer may have business experience but may be very technically inexperienced. Therefore, the information provided to the customer may be too advanced and therefore of little use to the customer.

From the foregoing, it can be appreciated that it would be desirable to have a source for customer support in which the information most relevant to the customer can be easily accessed. In addition, it would be desirable to have a source which provides this information at a technical level that is well suited for the customer. With such a source, the customer's needs would be more efficiently and effectively served.

### SUMMARY OF THE INVENTION

The present disclosure relates to a system and method for providing personalized customer support. The method comprises receiving information from a customer, evaluating the customer information, identifying customer support information relevant to the customer information, and presenting the relevant customer support information to the customer. In a preferred arrangement, the relevant customer support information is presented to the customer with one or more automatically generated, personalized web pages.

The system can comprise means for receiving information from a customer, means for evaluating the customer information, means for identifying customer support information relevant to the customer information, and means for presenting the relevant customer support information to the customer. Alternatively, the system can comprise logic configured to receive information from a customer, logic configured to evaluate the customer information, logic configured to identify customer support information relevant to the customer information, and logic configured to present the relevant customer support information to the customer.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic illustrating a system over which personalized customer support can be provided.

FIG. 2 is a schematic illustrating an example architecture of a web server shown in FIG. 1.

FIG. 3 is a flow chart illustrating the functionality of a web page module shown in FIG. 1.

FIG. 4 illustrates an example personalized home page generated by the web server shown in FIGS. 1 and 2.

FIG. 5 illustrates an example personalized training page generated by the web server shown in FIGS. 1 and 2.

FIG. 6 illustrates an example personalized issue dispatch page generated by the web server shown in FIGS. 1 and 2.

FIG. 7 illustrates an example personalized troubleshooting page generated by the web server shown in FIGS. 1 and 2.

FIG. 8 illustrates an example personalized database search page generated by the web server shown in FIGS. 1 and 2.

FIG. 9 illustrates an example personalized database search results page generated by the web server shown in FIGS. 1 and 2.

FIG. 10 illustrates an example personalized design assistance page generated by the web server of FIGS. 1 and 2.

FIG. 11 illustrates an example personalized design results page generated by the web server shown in FIGS. 1 and 2.

FIG. 12 illustrates an example personalized strategic planning assistant page generated by the web server shown in FIGS. 1 and 2.

FIG. 13 illustrates an example personalized strategic planning assistant results page generated by the web server shown in FIGS. 1 and 2.

FIG. 14 illustrates an example personalized solution alternatives page generated by the web server shown in FIGS. 1 and 2.

FIG. 15 illustrates an example personalized e-mail dispatch page generated by the web server of FIGS. 1 and 2.

FIG. 16 illustrates an example personalized profile page generated by the web server shown in FIGS. 1 and 2.

FIG. 17 illustrates an example personalized profile update page generated by the web server shown in FIGS. 1 and 2.

### DETAILED DESCRIPTION

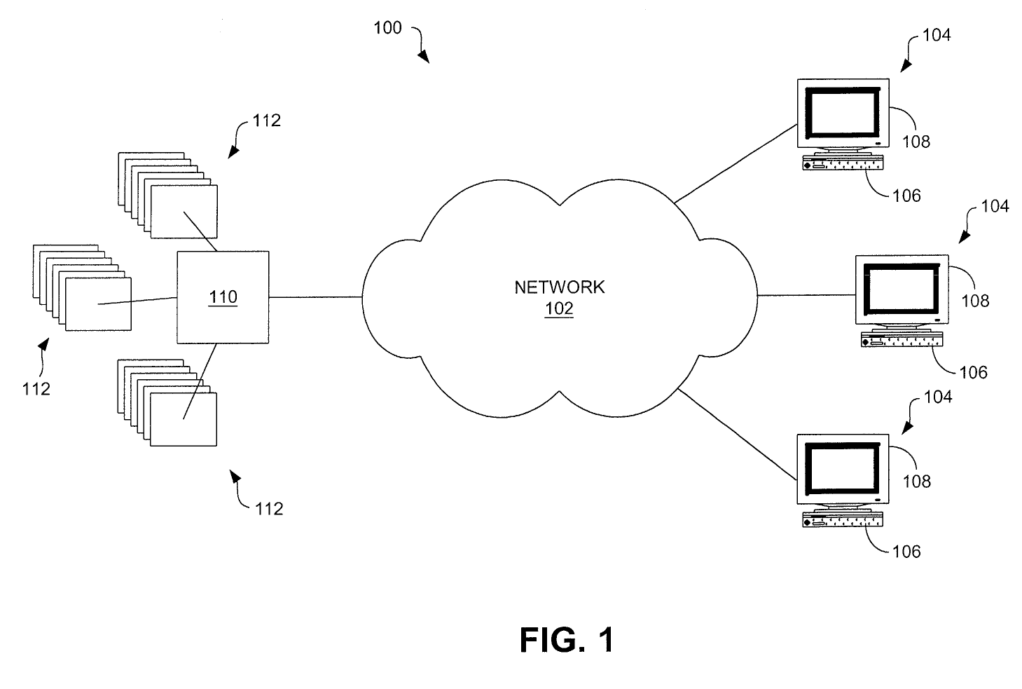

Referring now in more detail to the drawings, in which like numerals indicate corresponding parts throughout the several views, FIG. 1 illustrates a system 100 over which personalized customer support can be provided. As illustrated in this figure, the system 100 includes a network 102 that normally comprises the Internet and the various infrastructure over which the Internet operates. Although the Internet is presently preferred, it will be understood that alternative communications networks, as well as combinations thereof, could be used if desired. As is further identified in FIG. 1, the system 100 can include a plurality of customer computing devices 104 that are connected to the network 102. As is discussed in greater detail below, these customer computing devices 104 can be used by customers to access personalized customer support over the system 100. By way of example, the customer computing devices 104 can each comprise a desktop computer 106 and an associated monitor 108. Although this configuration is illustrated in FIG. 1, it will be appreciated that alternative configurations are feasible and may be preferable.

Also connected to the network 102 is a web server 10. As indicated in FIG. 1, this web server 110 is capable of generating and maintaining one or more series 112 of personalized web pages that can be accessed by customers through use of the customer computing devices 104. As is explained below, these personalized web pages provide customer support to the customers, and, more particularly, support that is particular to the customers in some manner.

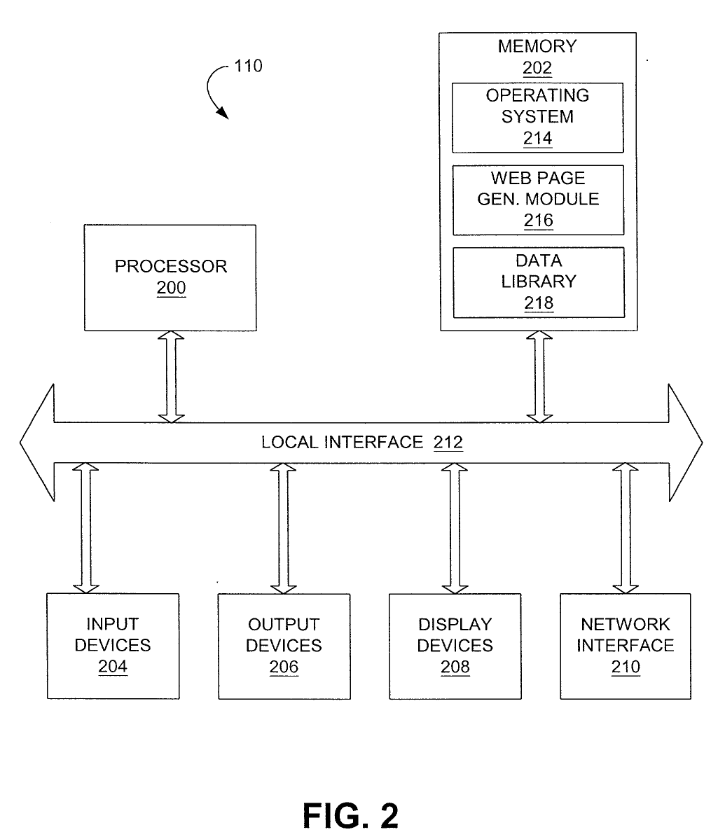

FIG. 2 illustrates an example architecture of the web server 110 shown in FIG. 1. As indicated in FIG. 2, the web server 110 normally comprises a processor 200, a memory 202, one or more input devices 204, one or more output devices 206, one or more display devices 208, a network interface 210, and a local interface 212 to which each of the web server components is electrically connected. By way of example, the processor 200 can comprise one or more computer processor units (CPUs). Accordingly, although a single web server 110 is shown and discussed herein, it will be appreciated that this web server can actually comprise two or more servers that operate in conjunction. Moreover, although a web server is preferred, it will be understood that alternative computing devices capable of similar functionality can be used.

The memory 202 comprises any calibration of volatile and nonvolatile memory elements, but preferably volatile random access memory (RAM) as well as nonvolatile storage memory (e.g., one or more hard disks or other storage media) that store data within the web server 110. The input devices 204 typically comprise user interface devices, such as a keyboard and mouse, with which a user (e.g. a system administrator) can operate and control the web server 110. In addition, these input devices 204 normally include interface components through which data can be received from a system user (e.g., customer). Similarly, the output devices 206 normally include interface components through which data can be transmitted from the web server 10 to the system user. The display devices 208 normally comprise one or more computer monitors with which the system administrator(s) can visually interface. Finally, the network interface 210 can comprise a device with which the server 110 can transmit and receive information to and from the network 102, for example, a modem.

The memory 202 stores an operating system 214 comprising the various execution commands for operating the web server 110. In addition, the memory 202 stores a web page generation module 216 that contains the various commands needed for generation, maintenance, and control of web pages that are displayed to a customer via the customer computing devices 104. The web page generation module 216 preferably comprises software and/or firmware. When configured in this manner, the module 216 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer-readable medium can be, for example, an electronic, magnetic, optical, electromagnetic, infrared, or semi-conductor system, apparatus, device, or propagation medium. More specific examples (a non-exhaustive list) of the computer-readable medium includes the following: an electrical connection (electronic) having one or more wires, a portable computer diskette (magnetic), a RAM (electronic), a read-only memory (ROM) (electronic), an erasable programmable read-only memory (EPROM) or Flash memory (electronic), and optical fiber (optical), and a portable compact disk read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

In addition to the operating system 214 and the web page generation module 216, the memory 202 can include a data library 218 that contains a plurality of data modules containing customer support information. As is discussed below, the data modules can be used to create the personalized customer support web pages. In use, the web server 110 and, more particularly the web page generation module 216, can be used to provide personalized customer support over the Internet. By way of example, this customer support can provide training as to the initialization and configuration of products owned by the customer, troubleshooting as to problems the customer is experiencing with these products, detailed textual information as to the products, notification as to new software for the products, notification as to new products the customer may need, and other information particular to the customer. In order to personalize the information presented to the customer, information is first collected about the customer and its business to create a customer profile. This information can be obtained in various ways. By way of example, this information can be obtained through customer registration of a newly-purchased product. This registration can be manually effected by the customer by filling out a form accompanying the product literature, or by a sales representative that has sold the product to the customer. Alternatively, registration can be effected online by accessing an online registration form at any time.

Preferably, the customer information used to form the customer profile is obtained through a survey facilitated online via the Internet by web server 110. In such a scenario, the survey can comprise a series of questions (e.g., presented over a series of web pages) that query the customer as to its business, the products the customer owns, and the customer's technical level of expertise. To simplify analysis of the customer responses and facilitate automatic generation of the customer support web pages, some of the queries can be in the form of multiple choice questions. Optionally, the amount of information obtained by the web server 110, and therefore, the length of the survey, can be pre-selected by the customer. In this manner, the customer can choose to complete a simple or detailed version of the survey, as desired. With regard to the customer's business, the survey can query the customer as to the type and volume of the business, the number and size of its locations, the number of users of its computing equipment, the nature of the use including the frequency of use and manner of use, the configuration of the various office locations, and so forth. Where the business includes multiple locations, it will be appreciated that separate personalized customer support (e.g., a separate series of personalized web pages) can be generated for each office, if desired. In addition, the business information requested can include contact information of one or more persons associated with the business that will normally access the personalized web pages in search of support.

As for product information, the system can query the customer as to the make and model of the various products owned by the customer (including third party products), the network configuration used by the customer, the applications used by the customer, software owned by the customer, present optimization configurations, etc. Finally, with respect to technical expertise, the survey can query the customer as to the level of expertise of the person or persons that will be accessing the personalized web pages. Optionally, the survey can provide the customer with a choice as to the level of technical expertise the provided information will require. For example, three different technical levels can be identified, namely a novice level, intermediate level, and advanced level. Accordingly, in addition to providing information pertinent to the customer's business and its products, the personalized web pages can be tailored to match the technical skill level of the person or person(s) that will access this information.

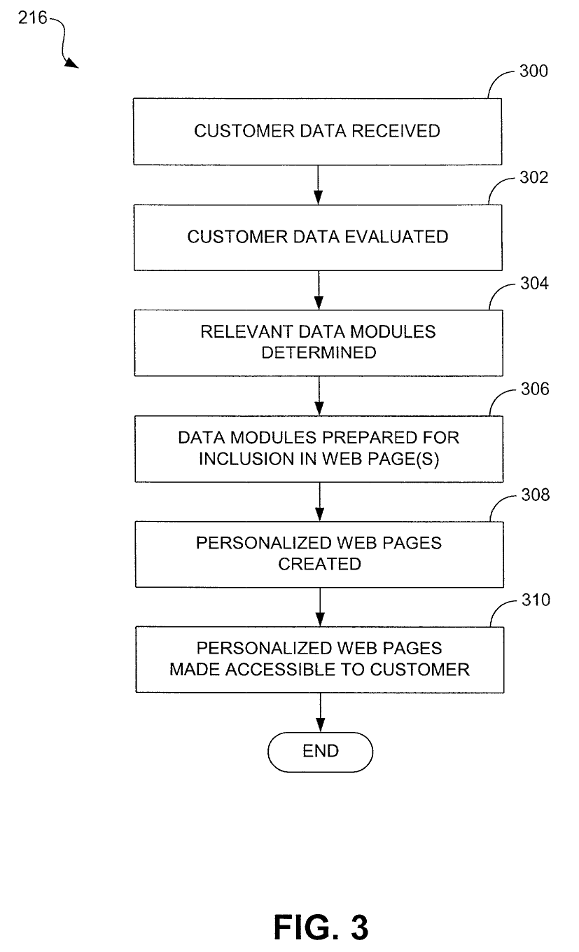

Once the customer registration information has been received by the web server 110, one or more personalized web pages can be generated. This process is typically performed by the web page generation module 216 shown in FIG. 2. FIG. 3 illustrates the functionality of the web page generation module 216 in such a scenario. With reference to 300, the web page module 216 first receives the customer data, e.g., obtained on-line through the customer survey. Once received, the data can be used by the web page module 216 to generate various personalized web pages. To do this, the module evaluates the customer provided data, as indicated in block 302, and determines which data modules of the data module library are pertinent to these data, as indicated in block 304. This step can, for instance, be accomplished by matching designations assigned to customer responses with like designations assigned to the pertinent data modules. In this manner, each customer response can be cross-referenced with a comprehensive set of data modules so that all relevant information can be presented to the customer. To ensure the correct technical level information is provided to the user, this process can further entail matching the customer's response with the one or more data modules that pertain to a customer response both in subject matter and degree of technicality.

Once the pertinent data modules have been determined by the web page generation module 216, the web page generation module prepares the data modules for inclusion in one or more web pages, as indicated in block 306. Typically, this step comprises determining the appropriate location (e.g., which web page) for each data module as well as formatting the modules to satisfy predetermined aesthetic requirements. After the data modules have been prepared, the web page generation module 216 creates the one or more personalized web pages, as indicated in block 308. By way of example, this process can entail populating web page shells with the data modules that have been determined to be relevant to the customer. At this point, the web page(s) can be made accessible to the customer, as indicated in block 310. Typically, this step involves pasting the web page(s) on the Internet and, more particularly, the WorldWide Web.

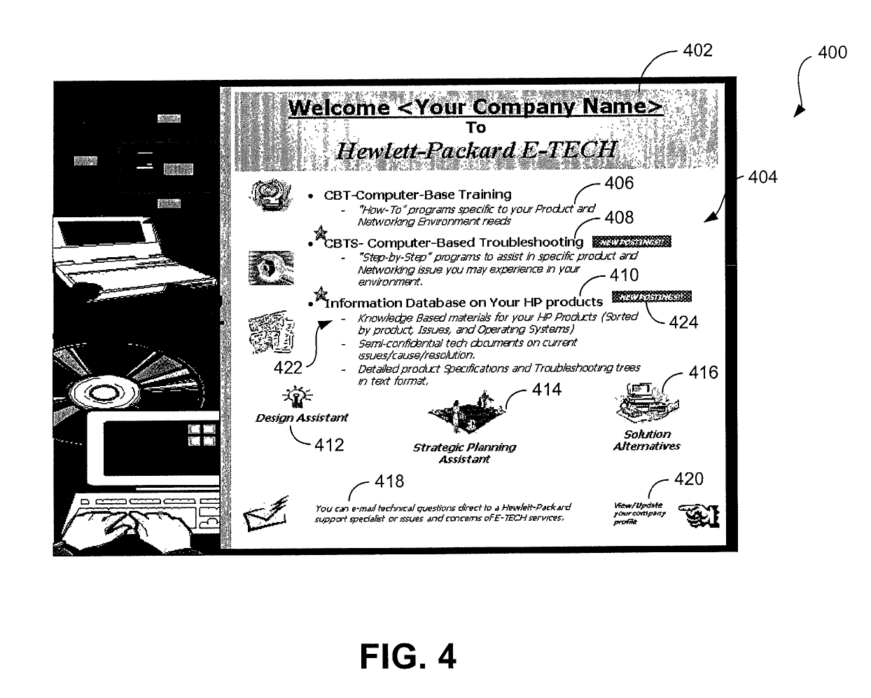

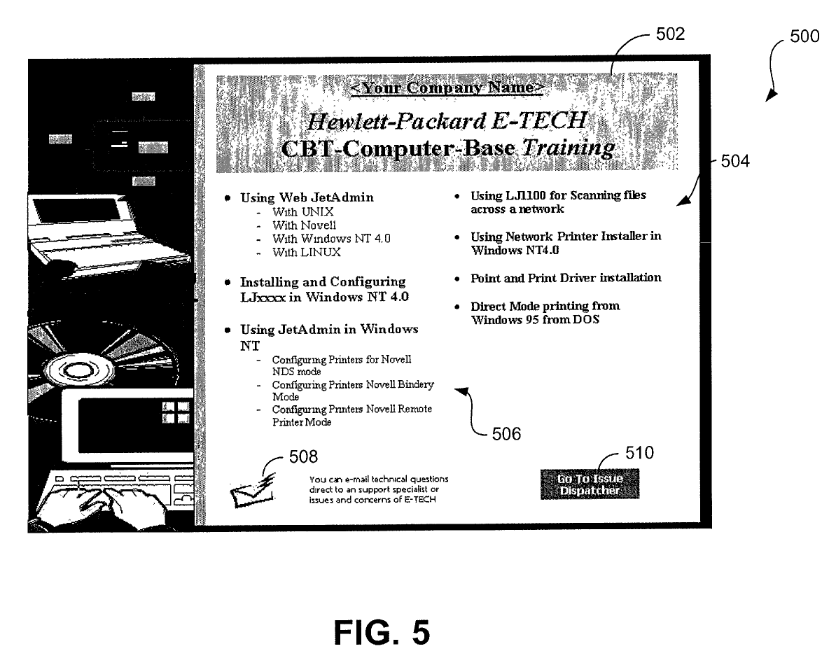

FIGS. 4-7 illustrate example personalized web pages of the type that can be generated by the web page generation module 216 in response to input customer data. Typically, each of these pages can be accessed with an appropriate customer computing device 104 (FIG. 1) operating appropriate web browser software. With reference to FIG. 4, illustrated is a personalized home page 400. It is to be noted that the page configuration shown in FIG. 4, as well as FIGS. 5-7, is presented for purposes of example only and is not intended to limit the scope of the present disclosure. Moreover, it is to be understood that the customer can be provided with appropriate means to alter the arrangement of these pages to further personalize them in a manner desired by the customer.

As indicated in FIG. 4, the personalized home page 400 includes a heading 402, which normally identifies the customer by name. Underneath the heading, is a plurality of links 404 that pertain to specific features associated with the home page 400. In the example shown in FIG. 4, these links 304 include a training link 406, a troubleshooting 408, a database link 410, a design assistant link 412, a strategic planning assistant link 414, a solution alternatives link 416, an e-mail dispatch link 418, and a profile link 420. As is discussed below, each of these links 404 normally is used to access one or more other personalized web pages generated and maintained by the web page generation module 214. Examples of several of these pages are provided in the descriptions associated with FIGS. 5-16. As is further indicated in FIG. 4, some of the links 404 can include associated feature descriptions 322 that identify the nature of the features accessible by selecting the appropriate links. In addition to these descriptions 422, the personalized home page 400 can also include new posting alerts 424 that call the customer's attention to new postings associated with particular features. For instance, as indicated in the example of FIG. 4, new posting alerts 424 are shown in association with the troubleshooting link 408 and the database link 410.

When the training link 406 is selected, the user is presented with a personalized training page 500 illustrated in FIG. 5. As with the home page 400, the training page 500 includes a personalized heading 502. Underneath this heading 502 is a plurality of links 504 that are relevant to the customer's profile created through the registration process. Accordingly, by way of example, these links 504 can pertain to specific equipment, software, and combinations thereof that the customer currently uses. For instance, the first of the links 504 shown in the example page 500 relates to Web JetAdmin™, indicating that the customer currently uses Web JetAdmin™ software. In addition to these links 504, the training page 500 can include feature descriptions 506 pertinent to each of the links 504. In use, these links 504 can be selected by the customer to obtain specific information about the products identified by the links. This information is normally presented in the form of tutorial information for the initialization configuration of the products identified on the page 500. In a preferred embodiment, selection of these links 504 results in the relevant information being presented to the user in one or more types of non-textual media. These media can comprise audio and/or video (e.g., mpegs, streaming video, etc.) that not only describe the product initialization and configuration procedures, but also shows the customer how to proceed. For example, a video clip can be presented to the customer that shows a printer being installed and prepared for use. Typically the non-textual media is presented to the customer in a “pop-up” window (not shown) that, at least temporarily, overlaps the training page 500. Where more than one module of information relevant to the link 504 exists, selection of the link can deliver the customer to a further training page or pages (not shown) where these modules can be accessed. Arranged in this manner, the customer can obtain the necessary training information in a highly convenient and efficient manner.

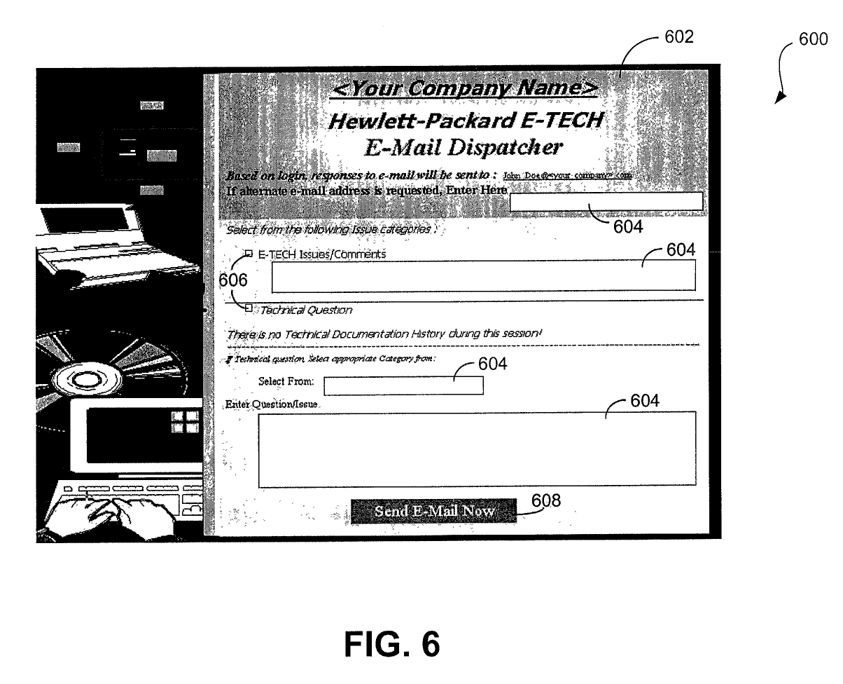

In addition to the links 504 described above, the training page 500 can include an e-mail dispatch link 504 and an issue dispatch button 510. With reference to FIG. 6, illustrated is a personalized e-mail dispatch page 600 accessible by selection of the e-mail dispatch link 504. The e-mail dispatch page 600 includes a personalized heading 602 and a variety of text fields 604 and check boxes 606 with which the customer can enter textual information and indicate various selections, respectively. Accordingly, with the text fields 604 and the check boxes 606, the customer can identify certain issues as well as make comments and/or pose questions the customer may have about products supported by the system. Once the information has been identified, it can be directed to the web server 110, and a customer service representative, by selecting a send e-mail button 608. The customer can then await a reply directed to an e-mail address specified in the customer profile.

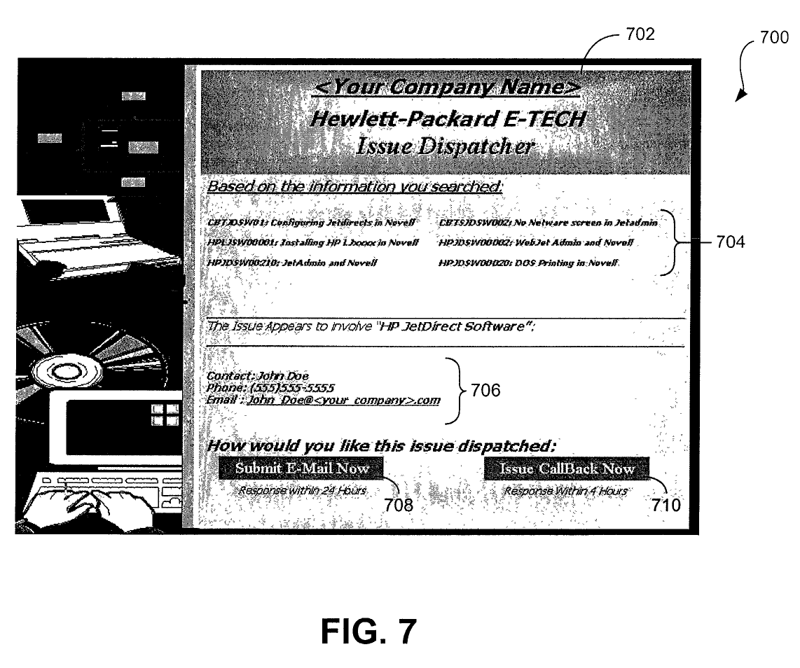

Selection of the issue dispatch button 510 presents the customer with an issue dispatch page 700 illustrated in FIG. 7. As indicated in this figure, the issue dispatch page 700 includes a personalized heading 702 as well as a listing 704 of particular topics the customer has “investigated” while navigating the various personalized web pages up to the point at which the issue dispatch button 510 was selected. For instance, if the user had previously selected links pertaining to Web JetAdmin™, the listing 704 would note this fact in the issue dispatch page 700. Accordingly, the listing 704 provides a summary of the user's session navigating the personalized web pages. This feature both provides the customer with a review of what information was accessed and helps customer services representatives narrow the field of possible issues with which the customer is concerned when the customer poses an issue for the representatives. Below the listing 704, the customer's contact information 706 can be provided. By way of example, this information 706 can identify a particular customer employee as well as his or her phone number and e-mail address. The issue dispatch page 700 further includes an e-mail dispatch button 708 used to e-mail the issue to the customer service representative and an issue call back button 610 used to prompt a customer service representative to contact the customer at the phone number identified in the contact information 706. Accordingly, through the provision of the e-mail dispatch button 708 and the call back button 710, a particular customer issue can be directly addressed by a human being that either directly responds to the customer via e-mail or telephone.

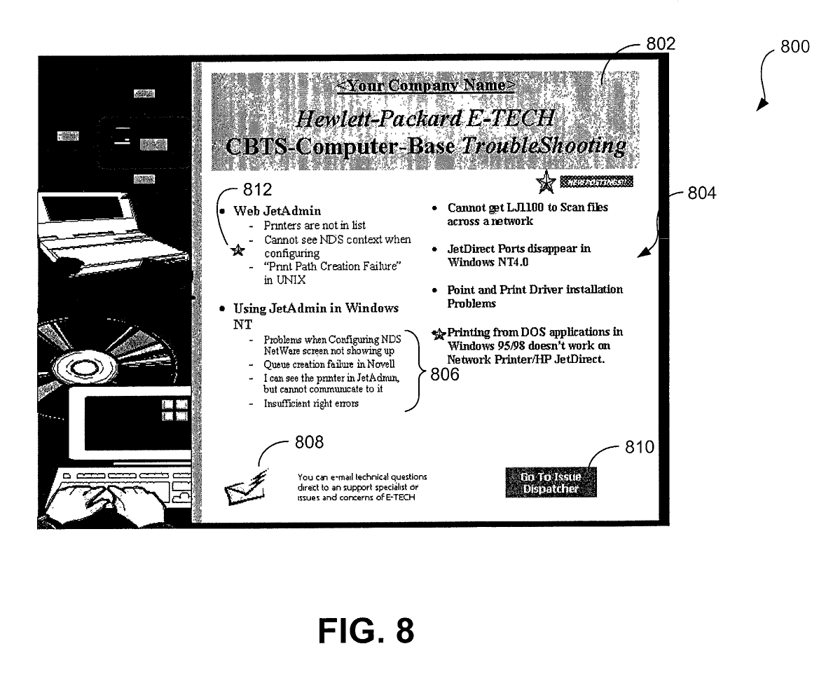

Returning to FIG. 4 and the personalized home page 400, the customer can further obtain troubleshooting information from the system by selecting the troubleshooting link 408. Selection of this link 408 presents the customer with a personalized troubleshooting page 800 illustrated in FIG. 8. As indicated in this figure, the troubleshooting page 800 includes a personalized heading 802 similar to that one described above and a plurality of links 804 that are relevant to the information contained within the customer profile. As with the training page 500, the troubleshooting page 800 can include feature descriptions 806 that describe the features that can be accessed by selecting an associated link 804. Unlike the training page 500, however, the troubleshooting page 800 is directed at solving problems that are being experienced by the customer with one or more of the supported products. By way of example, these problems can be individually identified with the links 804. When one of the links 804 is selected by the customer, information concerning the particular product and/or problem is provided to the customer. As with the training page 500, this information preferably is presented to the customer with various forms of non-textual media such as audio and/or video. Accordingly, the relevant information can be succinctly and efficiently communicated to the customer without requiring the customer to read through long sections of text.

The troubleshooting page 800 normally further includes an e-mail dispatch link 808 and an issue dispatch button 810 that are used in similar manner to the like-named features described above with reference to FIG. 5. As is further identified in FIG. 8, troubleshooting new postings to the troubleshooting page 800 are highlighted with a new postings indicator 812, for instance a star icon. This indicator 812 is used to identify new postings to the customer to ensure the customer sees the most up-to-date information. By way of example, postings that have been posted since the last time the customer accessed the personalized web pages can be highlighted. Alternatively, new postings can be any postings that have been recently posted by the web server 110 (e.g., within the last two weeks). Although the new postings indicator 812 has been described in relation to the troubleshooting page 800, it is to be understood that such an indicator can be used in similar manner in substantially any page generated by the web page module 214 to identify a new posting to the customer.

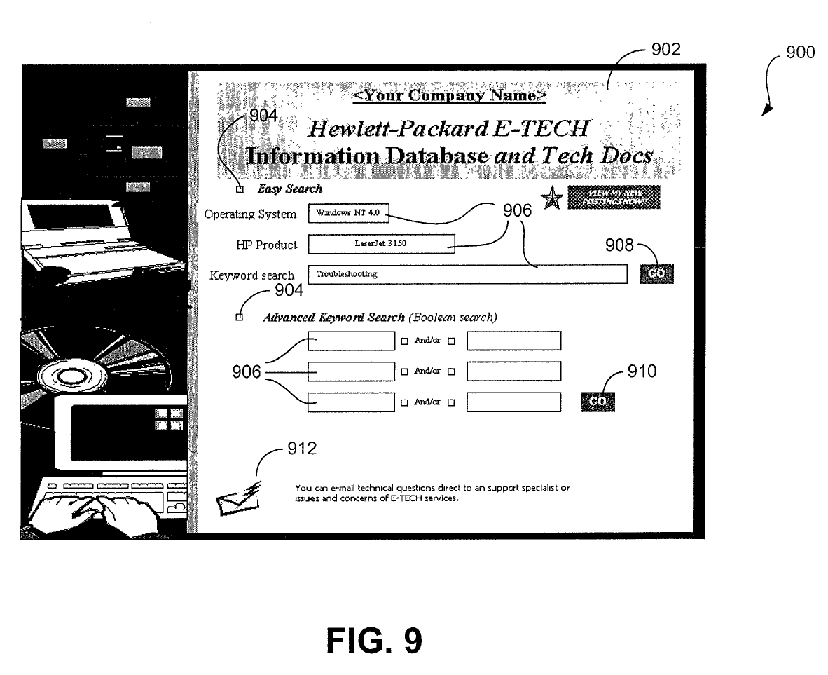

With reference back to FIG. 4, the customer can also access textual information about the products it owns (as well as other products available from the system host) by selecting the database link 410. With reference to FIG. 9, selection of the database link 410 presents the user with a database search page 900. As indicated in FIG. 9, the database search page 900 includes a personalized heading 902 as well as check boxes 904 and text fields 906 that can be used by the customer to create a search inquiry with which the customer can locate textual information stored within the web server 110, for instance, in data library 216. By way of example, the database searched can include technical documents, operation manuals, specifications. Accordingly, the database search page 900 can be used to locate highly detailed information that the customer may wish to access if the customer's needs have not been met by the training or troubleshooting pages 400 and 700, respectively.

In a preferred arrangement, the customer can be presented with the option to conduct an “easy search” or an “advanced” key word search (Boolean search). In the example shown in FIG. 8, the customer has determined to conduct an easy search for a LaserJet 3150™ cross-referenced with the Windows NT 4.0™ operating system and the key word “troubleshooting.” Once this information has been entered by the customer, the customer can select an enter button 808 or 812 with which the various elements of the search inquiry can be submitted to the web server 110 and the various search results presented to the customer. In addition to these features, the database search page 900 further can include an e-mail dispatch link 912.

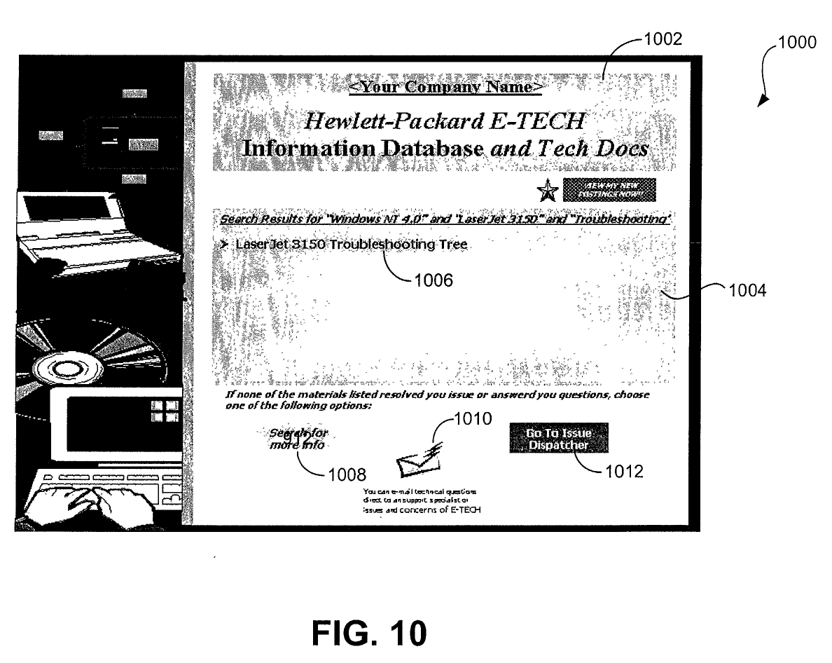

FIG. 10 illustrates a personalized database search results page 1000 in which the results to the search entered by the customer in the database search page 900 are presented to the customer. Again, the database search results page 1000 includes a personalized heading 1002. In addition, the page 1000 includes a search results window 1004 in which various links 1006 to information located by the web server 110 can be accessed. For instance, in the example shown in FIG. 10, the search results include a troubleshooting tree for a LaserJet 3150™. With the results page 1000, the customer can select the links 1006 presented in the search results window 1004 to access the pertinent information. If for some reason the information desired is not identified by the links 1006, the customer can initiate a new search by selecting the new search button 1008. As with other pages described above, the database search page 1000 can further include an e-mail dispatch link 1010 and an issue dispatch button 1012.

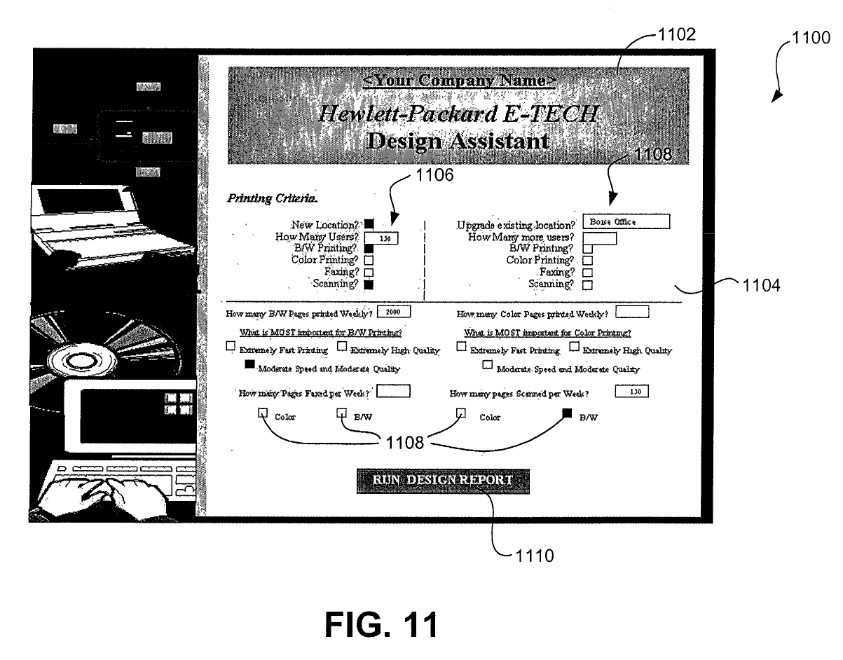

Returning to FIG. 4 and the personalized home page 400, the personalized web pages can further be used by the customer in designing a computing system, for example, a office network, that will best fit the customer's needs. In particular, when the customer selects the design assistant link 412, the customer is presented with a design assistant page 1100 shown in FIG. 11. Again, this page includes a personalized heading 1102. In addition, the design assistant page 1100 includes an information entry window 1104 with which the customer can input various information relevant to the computer system designing task. By way of example, this information entry window 1104 can include various check boxes 1106 and text fields 1108 that are used to enter this information. Examples of the type of information supplied by the customer in the information entry window 1104 include the number of users for the system, the features that are desired/required of the system (e.g., faxing, scanning, etc.), how many pages are printed weekly, and the like. This information, in conjunction with the information provided to the web server 110 through the customer survey process, provides the web page generation module 214 with enough information to identify the various components system that may be well suited for the customer in designing a computing system. By way of example, these components can be identified with reference to the data library 226.

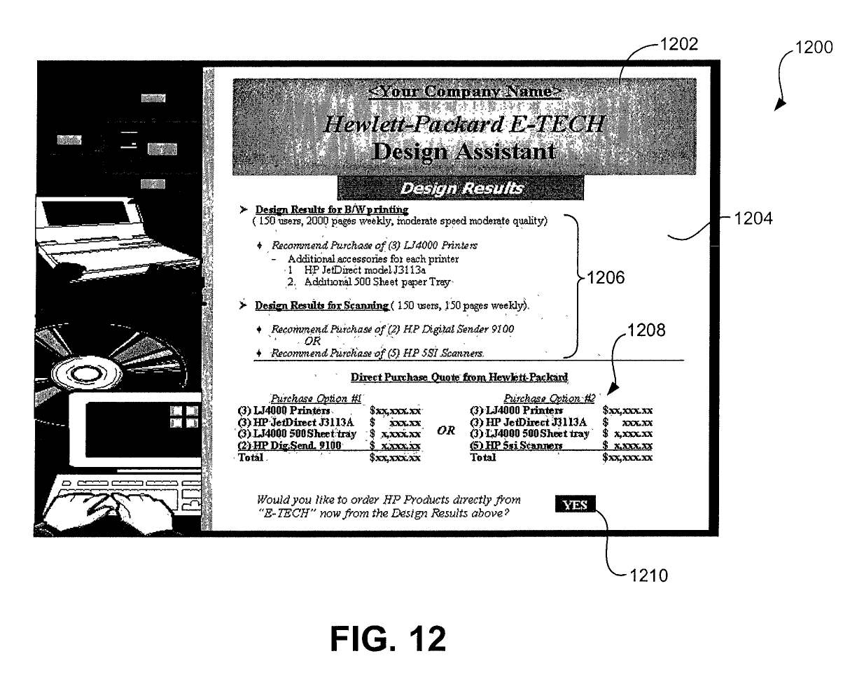

When the customer submits the information by selecting a run design report button 1110, the customer is presented with design results in a personalized design results page 1200 shown in FIG. 12. Once more, the design results page 1200 includes a personalized heading 1202. The design results page 1200 also includes a design results window 1204 that provides both information 1206 about the various products suggested by the system, and information 1210 about the costs of these products. If the customer is interested in purchasing one or more of these suggested products, the customer can select the product ordering button 1110 and be delivered to an appropriate order page (not shown) with which the customer can place an order.

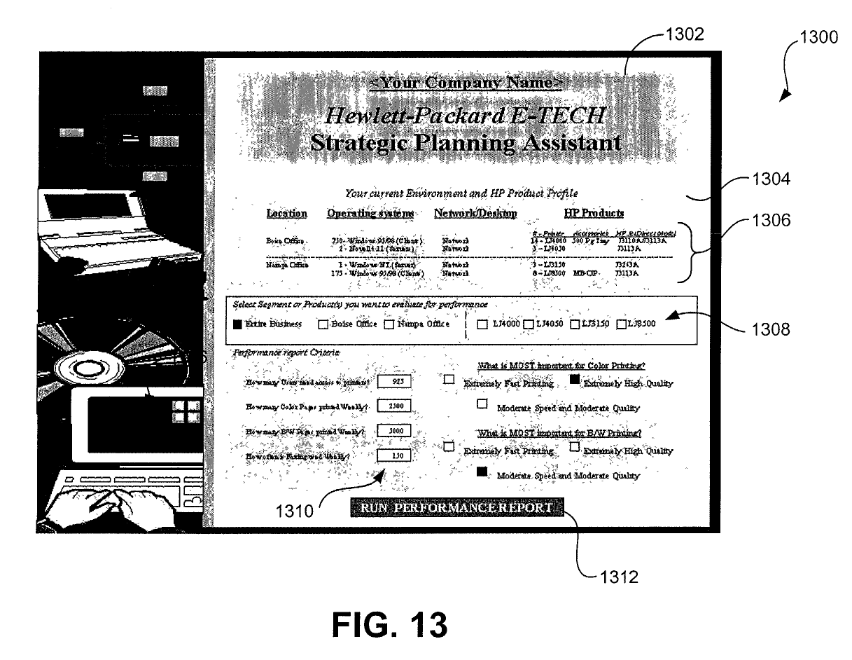

Returning again to FIG. 4, the web server 110 can also provide the customer with information as to the likely performance and optimization of its current computing system to indicate to the customer whether changes are needed. This information can be accessed by selecting the strategic planning assistance link 414. When this link 414 is selected, the customer is presented with a personalized strategic planning assistant page 1300 illustrated in FIG. 13. As shown in this figure, the strategic planning assistant page 1300 includes a personalized heading 1302 and an information entry window 1304. Identified in the information entry window 1304 is information concerning the customer's profile. In particular, provided is the customer's current computing system configuration 1306. In addition to this information 1306, the information entry window 1304 includes a plurality of check boxes 1308 and text fields 1310 with which the customer can enter certain information relevant to optimizing its computing system. For instance, the customer can enter information about how its computing system is currently used and what the customer sees as priorities for its system. Once the relevant information has been entered by the customer, it can be submitted by selecting the run performance report button 1312.

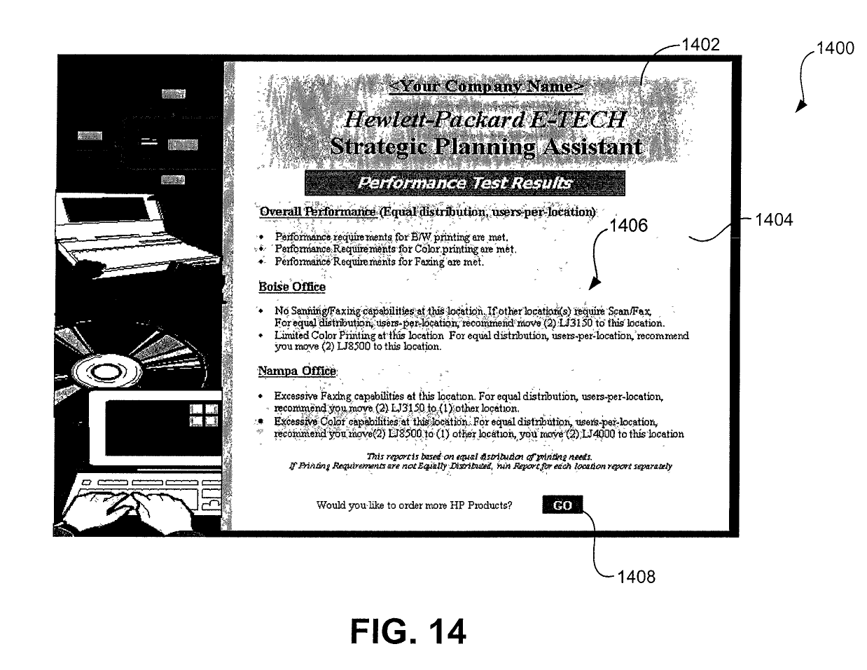

When the run performance report button 1312 is selected, the customer is presented with a personalized strategic planning assistants results page 1400 shown in FIG. 14. Once again, this page 1400 includes a personalized heading 1402. In addition, the page 1400 includes a performance test results window 1404 in which various information 1406 about the computing system performance is provided to the customer. Again, this information can be generated with reference to the data library 216. If several locations had been identified by the customer in the strategic planning assistant page 1400, this information can be broken down by these various locations. If, after reviewing the information provided in the performance test results window 1404, the customer wishes to obtain more information either about the products it currently uses or other products that may work well with its current system, the customer can select the product information button 1408 and be presented with information as to these products.

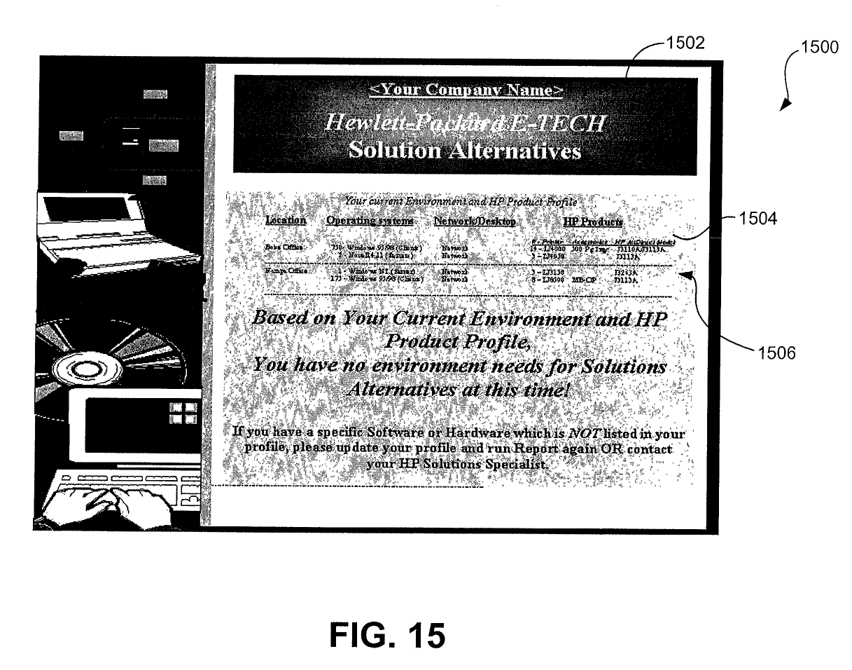

Returning once more to the personalized home page 400 shown in FIG. 4, the customer can also be presented with information as to solutions not currently provided by the system host. For instance, if after using the various links 404 provided in the personalized home page 400 the customer has not located the information it is seeking, the customer can select the solution alternatives link 416 to be provided with a solution alternatives page 1500 illustrated in FIG. 15. The solution alternatives page 1500 includes a personalized heading 1502 and an information window 1504. Normally, the information window 1504 provides information 1506 as to the current computing system configuration being operated by the customer and information as to products or services offered by third party vendors which may be helpful to the customer based on information that has been entered by the customer. Once more, the information about the third party products can be stored in the data library 216. By providing this information, the system host can aid the customer even where the system host does not currently offer a viable solution to the customer's problem or needs.

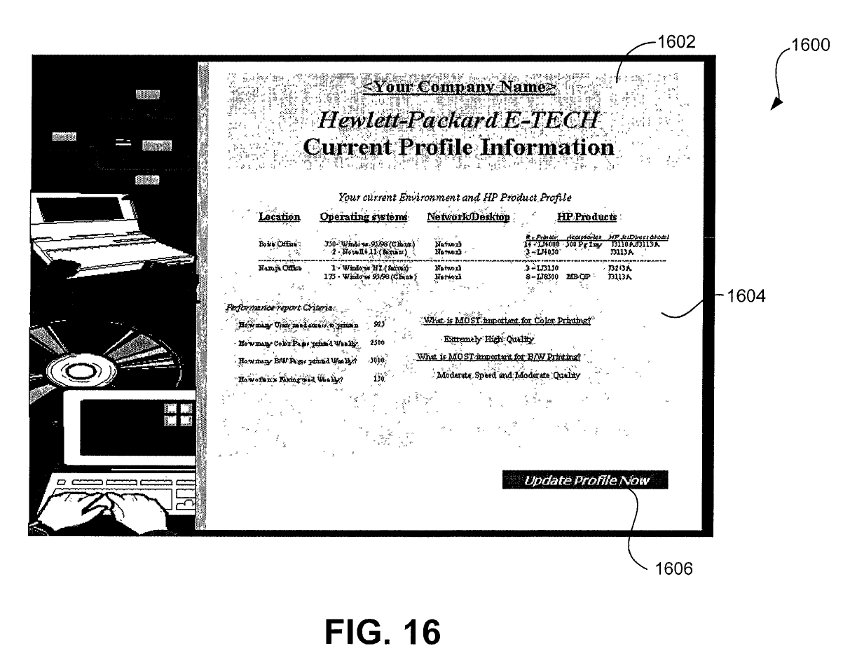

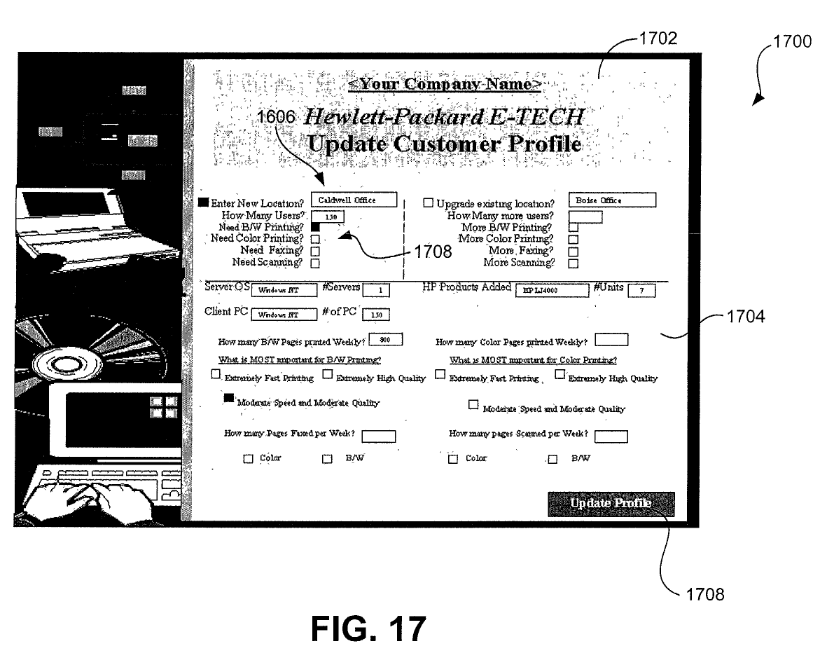

With reference again back to FIG. 4 and the personalized home page 400, the customer can also select the profile link 420 to view and/or amend the customer's profile. When this link 420 is selected by the customer, the customer is first brought to a personalized profile page 1600 illustrated in FIG. 16. This profile page 1600 includes a personalized heading 1602 as well as a current profile window 1604 in which various information as to the customer's profile is displayed. Where any of this information has changed, the customer can update the information by selecting the update profile now button 1608 and be provided with a personalized profile update page 1700 shown in FIG. 17. This page 1700 includes a personalized heading 1702 as well as an information window 1704 that comprises a plurality of text fields 1706 and check boxes 1708 with which the customer can enter the new information with the web server 110. Normally, the information addressed in the information window 1704 is similar to that initially received by the web server 110 during the initial registration process. Once the appropriate information has been entered by the customer, the update profile button 1708 can be selected, at which point the web server 110 makes the appropriate changes to the customer's profile for future reference.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing personalized customer support, comprising:
receiving information from a customer;
evaluating the customer information;
identifying customer support information relevant to the customer information; and
presenting the relevant customer support information to the customer.

2. The method of claim 1, wherein the step of receiving information comprises the step of receiving information about products the customer uses.

3. The method of claim 1, wherein the step of receiving information comprises the step of receiving information about the customer's business.

4. The method of claim 1, wherein the step of receiving information comprises the step of receiving information about the customer's technical expertise.

5. The method of claim 1, wherein the step of receiving information comprises the step of receiving information from an online customer survey.

6. The method of claim 1, wherein the step of identifying customer support information relevant to the customer information comprises the step of cross-referencing the customer information with information contained within a library database.

7. The method of claim 6, wherein the step of identifying customer support information relevant to the customer information further comprises the step of cross-referencing the customer information with data modules contained within the library database.

8. The method of claim 1, wherein the step of presenting the relevant customer support information to the customer comprises the step of automatically generating at least one personalized web page accessible to the customer.

9. The method of claim 8, wherein the at least one personalized web page only includes customer support information that is relevant to the products the customer uses and/or the customer's business.

10. The method of claim 8, wherein the step of presenting the relevant customer support information to the customer comprises the step of presenting audio and video instructions to the customer.

11. A system for providing personalized customer support, comprising:
means for receiving information from a customer;
means for evaluating the customer information;
means for identifying customer support information relevant to the customer information; and
means for presenting the relevant customer support information to the customer.

12. The system of claim 11, wherein the means for receiving information comprises means for receiving information about products the customer uses.

13. The system of claim 11, wherein the means for receiving information comprises means for receiving information about the customer's business.

14. The system of claim 11, wherein the means for receiving information comprises means for receiving information about the customer's technical expertise.

15. The system of claim 11, wherein the means for receiving information comprises means for receiving information from an online customer survey.

16. The system of claim 11, wherein the means for identifying customer support information relevant to the customer information comprises means for cross-referencing the customer information with information contained within a library database.

17. The system of claim 16, wherein the means for identifying customer support information relevant to the customer information further comprises means for cross-referencing the customer information with data modules contained within the library database.

18. The system of claim 11, wherein the means for presenting the relevant customer support information to the customer comprises means for automatically generating at least one personalized web page accessible to the customer.

19. The system of claim 18, wherein the at least one personalized web page only includes customer support information that is relevant to the products the customer uses and/or the customer's business.

20. The system of claim 18, wherein the means for presenting the relevant customer support information to the customer comprises means for presenting audio and video instructions to the customer.

21. A computer readable medium having software for providing personalized customer support, comprising:
logic configured to receive information from a customer;
logic configured to evaluate the customer information;
logic configured to identify customer support information relevant to the customer information; and
logic configured to present the relevant customer support information to the customer.

22. The computer readable medium of claim 21, wherein the logic configured to receive information comprises logic configured to receive information about products the customer uses.

23. The computer readable medium of claim 21, wherein the logic configured to receive information comprises logic configured to receive information about the customer's business.

24. The computer readable medium of claim 21, wherein the logic configured to receive information comprises logic configured to receive information about the customer's technical expertise.

25. The computer readable medium of claim 21, wherein the logic configured to receive information comprises logic configured to receive information from an online customer survey.

26. The computer readable medium computer readable medium of claim 21, wherein the logic configured to identify customer support information relevant to the customer information comprises logic configured to cross-reference the customer information with information contained within a library database.

27. The computer readable medium of claim 26, wherein the logic configured to identify customer support information relevant to the customer information further comprises logic configured to cross-reference the customer information with data modules contained within the library database.

28. The computer readable medium of claim 21, wherein the logic configured to present the relevant customer support information to the customer comprises logic configured to automatically generate at least one personalized web page accessible to the customer.

29. The computer readable medium of claim 28, wherein the at least one personalized web page only includes customer support information that is relevant to the products the customer uses and/or the customer's business.

30. The computer readable medium of claim 28, wherein the logic configured to present the relevant customer support information to the customer comprises logic configured to present audio and video instructions to the customer.

31. A method for providing personalized customer support, comprising:
receiving information from a customer about the products the customer uses and about the customer's business;
evaluating the customer information;
creating a customer profile based upon the evaluation of the customer information;
retrieving customer support information modules relevant to the customer profile; and
automatically generating a personalized web page containing the customer support information retrieved.

32. The method of claim 31, wherein personalized web pages relevant to training, troubleshooting, and database information are respectively automatically generated.

33. The method of claim 31, further comprising the step of responding to questions posed and issues raised by customers online.

34. The method of claim 31, further comprising the step of providing information as to designing a computing system specific to the customer's needs.

35. The method of claim 31, further comprising the step of providing an evaluation of the customer's existing computing system.
